(19) United States
(12) Patent Application Publication
(10) Pub. No.: US 2015/0324758 A1
(43) Pub. Date: Nov. 12, 2015

(54) Equipment Management System

(71) Applicant: The Walsh Group Ltd., Chicago, IL (US)

(72) Inventors: Timothy Nottoli, Palatine, IL (US); Jason Allen Reitz, Mokena, IL (US); Michael Patrick Gibbons, Western Springs, IL (US)

(73) Assignee: THE WALSH GROUP LTD., Chicago, IL (US)

(21) Appl. No.: 14/801,508

(22) Filed: Jul. 16, 2015

Related U.S. Application Data
(63) Continuation of application No. 12/469,119, filed on May 20, 2009.

(51) Int. Cl. G06Q 10/10; G06F 3/0482; G06F 3/0483; G06F 3/0484

(52) U.S. Cl. CPC G06Q 10/1097; G06F 3/04842; G06F 3/0482; G06F 3/0483

(57) ABSTRACT

A system may manage equipment distribution with an automated interface that is accessible over a network. The system may include data regarding a number of job sites and the equipment at each site, as well as any available equipment. The data may be monitored and updated for tracking, scheduling, and billing for the distribution of the equipment to job sites. In one example, a construction company may monitor and control the location of its construction equipment through an equipment management system that is also used by an operator of a job site for requesting the equipment needed for that job site. The equipment management system may handle the renting and assigning of equipment for each job site, as well as providing information regarding all the equipment and each job site.

### PRIORITY

This application claims priority as a continuation application to U.S. patent application Ser. No. 12/469,119, filed on May 20, 2009, entitled “EQUIPMENT MANAGEMENT SYSTEM”, the entire disclosure of which is hereby incorporated by reference.

### BACKGROUND

In many different business fields, companies may need to track or monitor assets. In some instances, companies may utilize inefficient asset tracking or equipment monitoring as part of an inventory process. The tracking and monitoring may be done by hand, or outdated computer systems may be used. For example, maintenance of an electronic list of asset locations may be used and manually updated to track the changing locations of various assets. Equipment rental businesses may monitor thousands of pieces of equipment at any one time for locations across the globe. The location and time frame of each piece of equipment may need to be known for future reservations of the equipment, as well as the transfers of equipment. Current rental systems may not be flexible enough to apply to different business areas and provide all the information necessary.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a network system for asset management;

FIG. 2 is an exemplary equipment management system;

FIG. 3 is an exemplary equipment list;

FIG. 4 is an exemplary schedule view;

FIG. 5 is an exemplary selection from another schedule view;

FIG. 6 is an exemplary selection from another schedule view;

FIG. 7 is an exemplary equipment details screen;

FIG. 8 is an exemplary equipment details screen for financial details;

FIG. 9 is an exemplary equipment details screen for assignment details;

FIG. 10 is an exemplary equipment details screen for repair and maintenance details;

FIG. 11A is another exemplary equipment details screen for repair and maintenance details;

FIG. 11B is an exemplary screen for resource scheduling that displays a work order view;

FIG. 11C is an exemplary screen for resource scheduling that displays a personnel schedule view by employee;

FIG. 11D is an exemplary screen for resource scheduling that displays details by work order;

FIG. 12 is an exemplary equipment details screen for preventative maintenance details;

FIG. 13 is an exemplary activity details screen;

FIG. 14 is an exemplary activity details screen for rate details;

FIG. 15 is an exemplary activity details screen for invoice history and forecast details;

FIG. 16 is an exemplary activity details screen for transfer details;

FIG. 17 is an exemplary inventory management screen for open requests;

FIG. 18 is an exemplary jobsite listing screen of open requests;

FIG. 19 is an exemplary rental rate screen;

FIG. 20 is an exemplary rate schedule screen;

FIG. 21 is an exemplary screen shot of functions for a job site operator;

FIG. 22 is an exemplary transfer request screen;

FIG. 23 is an exemplary job request screen; and

FIG. 24 is a chart of target utilization.

### DETAILED DESCRIPTION

A system for managing assets, such as construction equipment, may include an automated interface accessible by multiple entities for viewing asset information, scheduling and assigning of assets, viewing asset billing information, monitoring asset conditions, and tracking asset locations. In one example, a construction company may monitor and control the location of its construction equipment through an equipment management system that is also used by an operator of a job site for requesting and reserving the equipment needed for that job site. The equipment management system may handle the billing and renting of equipment for each job site, as well as providing information on all the equipment at each job site.

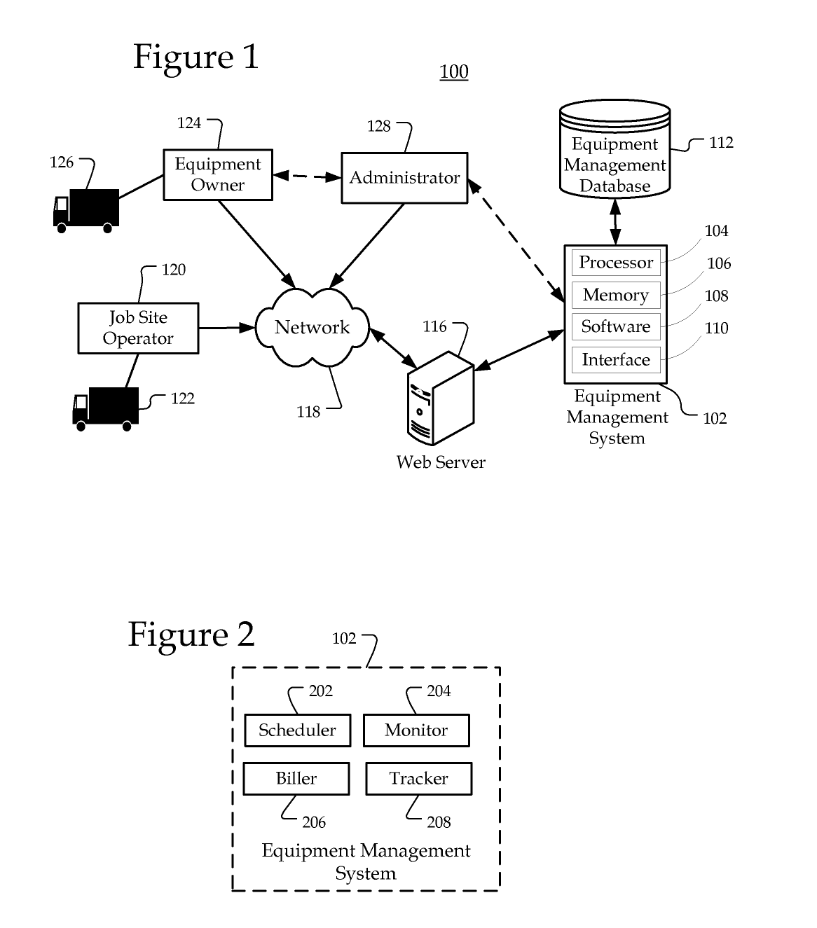

FIG. 1 is a network system 100 for asset management. For simplicity, an asset may be described as equipment pieces or construction equipment, but may also include anything of value including other property. The system may include an equipment management system 102 with an equipment management database 112 that is connected over a network 118 with a job site operator 120, an equipment owner 124, and/or an administrator 128. The equipment management system 102 may be coupled with a web server 116 for providing access over the network 118. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein.

In a construction environment, the job site operator 120 may be a field manager who is responsible for a particular project, which is referred to as a job site. Alternatively, a job may also be referred to as an activity. In addition, the job site operator may be any employee or contractor associated with a particular job or project. Although not shown, there may be multiple projects and at least one job site operator for each project. A construction company may be simultaneously working on a number of different jobs at any one time. Each job site may include equipment 122 that is being used at the job site. The job site operator 120 may be responsible for requesting additional equipment or updating the status of the equipment 122 that is currently at the job site. Accordingly, the job site operator 120 may access the equipment management system 102 over the network 118.

The equipment owner 124 may be the owner or operator of equipment 126 that is available for the job site operator 120. The equipment owner 124 may rent the equipment 126 to the job site operator 120. The equipment owner 124 may have a distribution area for equipment 126 to be rented out to job sites. The equipment owner 124 may be a construction company that owns the equipment that is rented to the job sites. The rent may be the value that is being charged to the customer paying for a particular job. The rent may be a part of a bid or billing for a construction job.

The administrator 128 may be the administrator of the equipment management system 102. The administrator 128 may be a third party that operates the equipment management system 102 for the equipment owner 124, or the administrator 128 may be the equipment owner 124. In one embodiment, the administrator 128 and the equipment owner 124 are part of a construction company that utilizes the equipment management system 102 for distributing equipment to construction projects and construction job sites. The job site operator 120 may also be an employee of the construction company or may be a contractor that accesses the equipment management system 102. The administrator 128 may have direct access to the system 102 rather than logging in through the network 118.

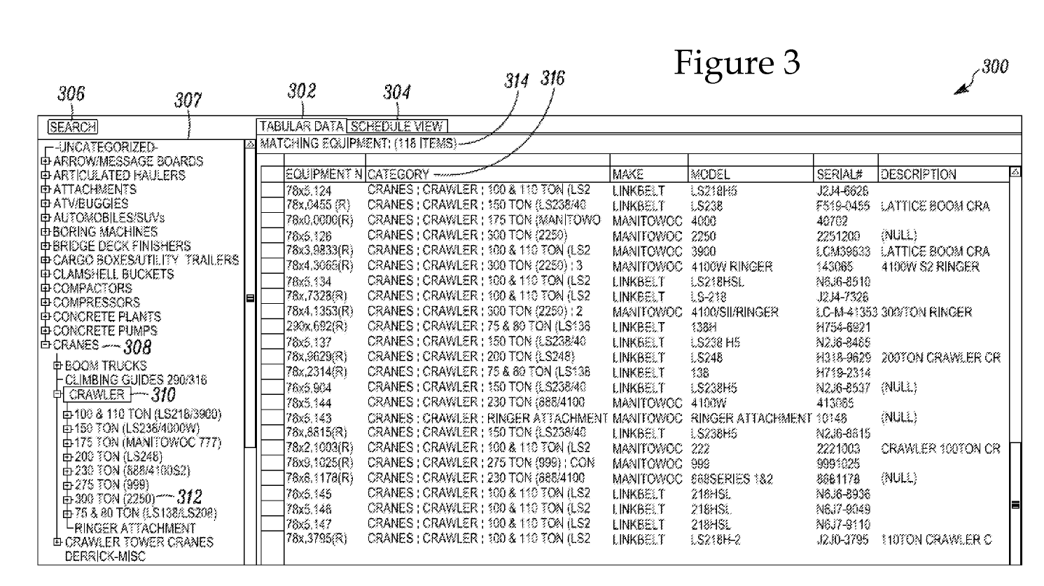

The equipment management system 102 may be embodied in part as a website that is accessible over the Internet by the job site operator 120 at a predefined web address. Accordingly, the data and information from the equipment management system 102 may be displayed as a web site or series of web pages. The equipment management system 102 may be part of an intranet network accessible by certain users. In an alternative embodiment, the equipment management system 102 may be a software program that is accessible over a network. As described below, the equipment management system 102 monitors, tracks, schedules, and provides billing for equipment that is distributed. The equipment management system 102 may be an inventory system for the equipment of a company, such as a construction company. The functions of the equipment management system 102 are further described below in FIGS. 3-24, which illustrate exemplary screen shots of the equipment management system 102.

As illustrated in FIG. 1, the equipment management system 102 is a computing device that includes a processor 104, memory 106, software 108, and an interface 110. The equipment management system 102 may be described as the software that runs on a computing device, or the equipment management system 102 may be described as the computing device (such as a server) that includes the software. The equipment management system 102 may be a separate component from the web server 116, or they may be combined as a single component. The interface 110 may communicate over the network 118 with any of the job site operator 120, equipment owner 124, administrator 128, or any other user who would like to access the equipment management system 102.

The processor 104 in the equipment management system 102 may include a central processing unit (CPU), a graphics processing unit (GPU), a digital signal processor (DSP) or other type of processing device. The processor 104 may be a component in any one of a variety of systems. For example, the processor 104 may be part of a standard personal computer or a workstation. The processor 104 may be one or more general processors, digital signal processors, application specific integrated circuits, field programmable gate arrays, servers, networks, digital circuits, analog circuits, combinations thereof, or other now known or later developed devices for analyzing and processing data. The processor 104 may operate in conjunction with a software program, such as code generated manually (i.e., programmed).

The processor 104 may be coupled with a memory 106, or the memory 106 may be a separate component. The interface 110 and/or the software 108 may be stored in the memory 106. The memory 106 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. In one embodiment, the memory 106 includes a random access memory for the processor 104. In alternative embodiments, the memory 106 is separate from the processor 104, such as a cache memory of a processor, the system memory, or other memory. The memory 106 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 106 is operable to store instructions executable by the processor 104.

The functions, acts or tasks illustrated in the figures or described herein may be performed by the programmed processor executing the instructions stored in the memory 106. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 104 is configured to execute the software 108. The software 108 may include instructions for monitoring, tracking, or scheduling equipment. A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device.

The memory 106 may store instructions, such as the software 108 that is operable by the processor 104. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The interface 110 may be a user input device or a display. The interface 110 may include a keyboard, keypad or a cursor control device, such as a mouse, or a joystick, touch screen display, remote control or any other device operative to interact with the equipment management system 102. The interface 110 may include a display coupled with the processor 104 and configured to display an output from the processor 104. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 104, or as an interface with the software 108 for providing input parameters. In particular, the interface 110 may allow a user to interact with the equipment management system 102 to schedule, monitor, or track equipment. In one embodiment, the interface 110 may be directly accessible by the administrator 128, and other users can access the equipment management system 102 only through a network.

Any of the components in system 100 may be coupled with one another through a network, such as the network 118. In particular, the job site operator 120, the equipment owner 124, and/or the administrator 128 includes a computing device that accesses the equipment management system 102 over the network 118. Any of the components in system 100 may include communication ports configured to connect with the network 118. The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

In addition to the memory 106 or in place of the memory, the equipment management system 102 may be coupled with the equipment management database 112. The database 112 may store the equipment information, including scheduling, monitoring and billing information that is used by any of the job site operator 120, the equipment owner 124, or the manager 128. In particular, the database 112 may store any of the data or information that is displayed in FIGS. 3-24.

FIG. 2 is an exemplary equipment management system 102. The equipment management system 102 may include functions performed by a scheduler 202, a monitor 204, a biller 206, and/or a tracker 208. In one embodiment, the monitor 204 and the tracker 208 may be performed by a single component. In other words, the functions described below for the tracker 208 may be performed by the monitor 204, or vice-versa.

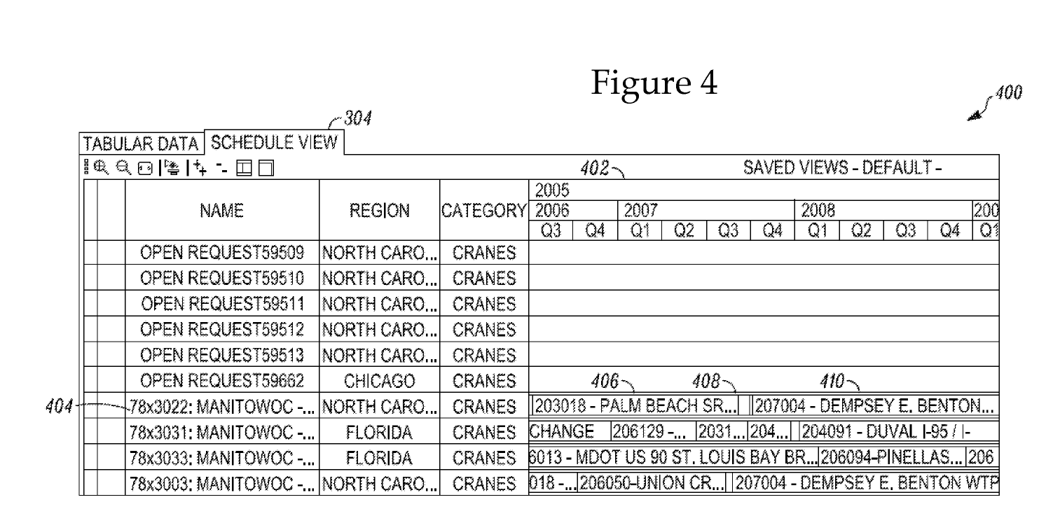

The scheduler 202 may include the function of receiving and maintaining reservations for each piece of equipment. Each piece of equipment may include a list of all past projects/jobs as well as current and future projects/jobs (FIGS. 4-6, and 17). Accordingly, the scheduler may be used to reserve a piece of equipment that either is not currently being used or has an availability period in the future. The scheduler 202 may also be referred to as assigning equipment to a particular job site.

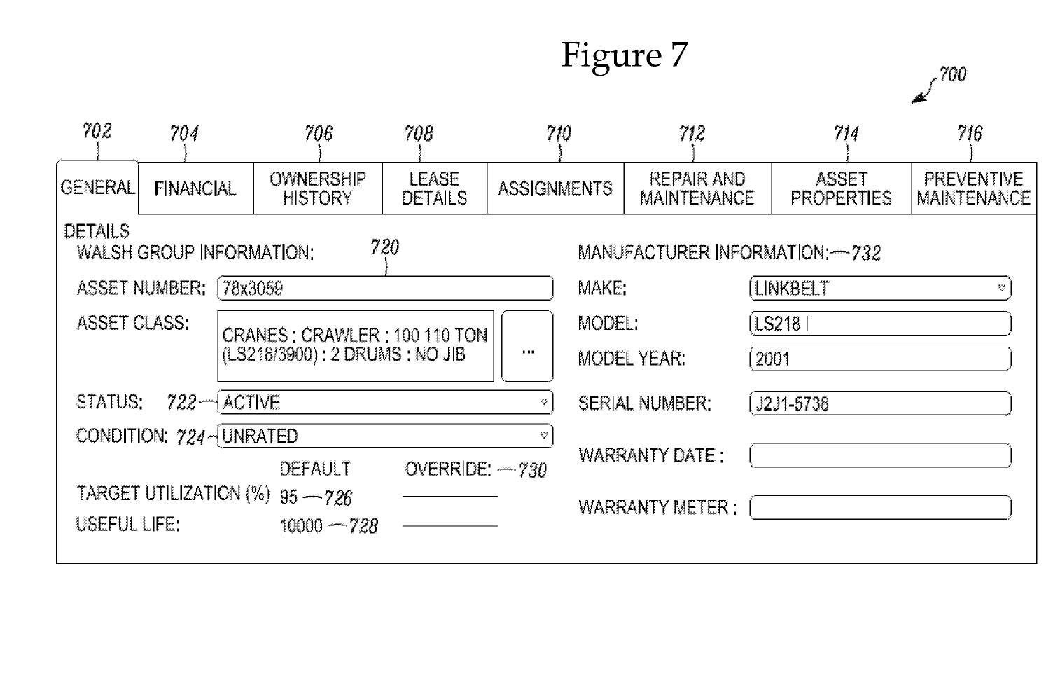

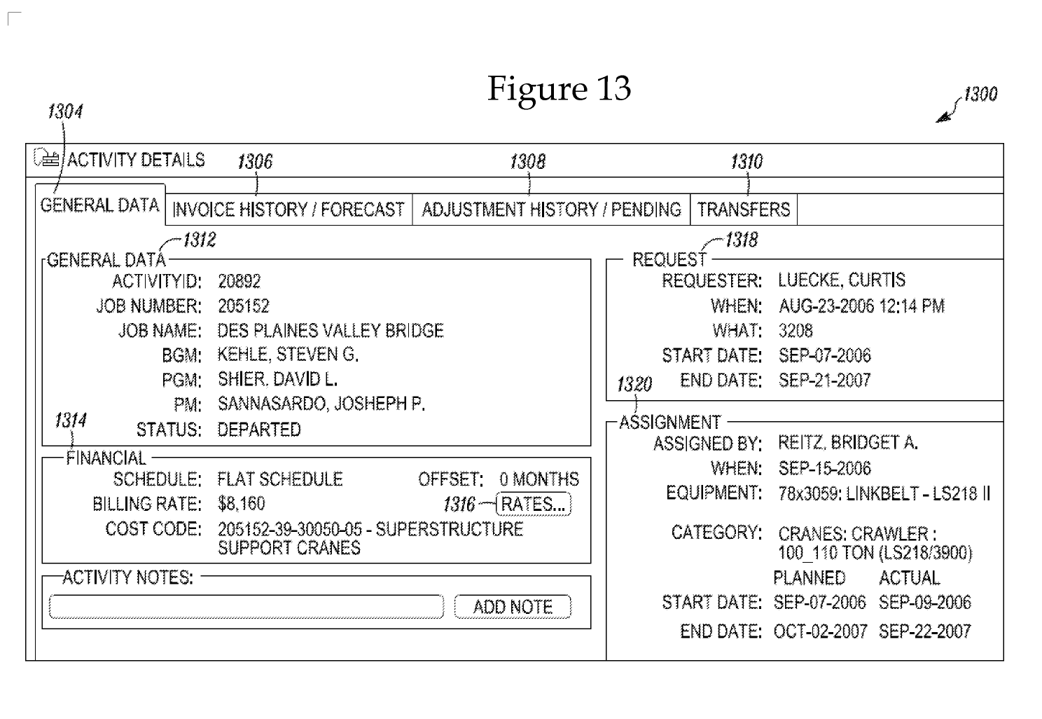

The monitor 204 may include the functions of viewing inventory listings (FIG. 3) or viewing equipment details (FIGS. 7-11). The monitor 204 may also be described as an inventory manager that provides, displays, and updates information regarding the equipment and activities/jobs. Further, the monitor 204 may display activity details (FIG. 13). Equipment and/or activity details may be updated to reflect changes, such as additional equipment or equipment that is no longer available.

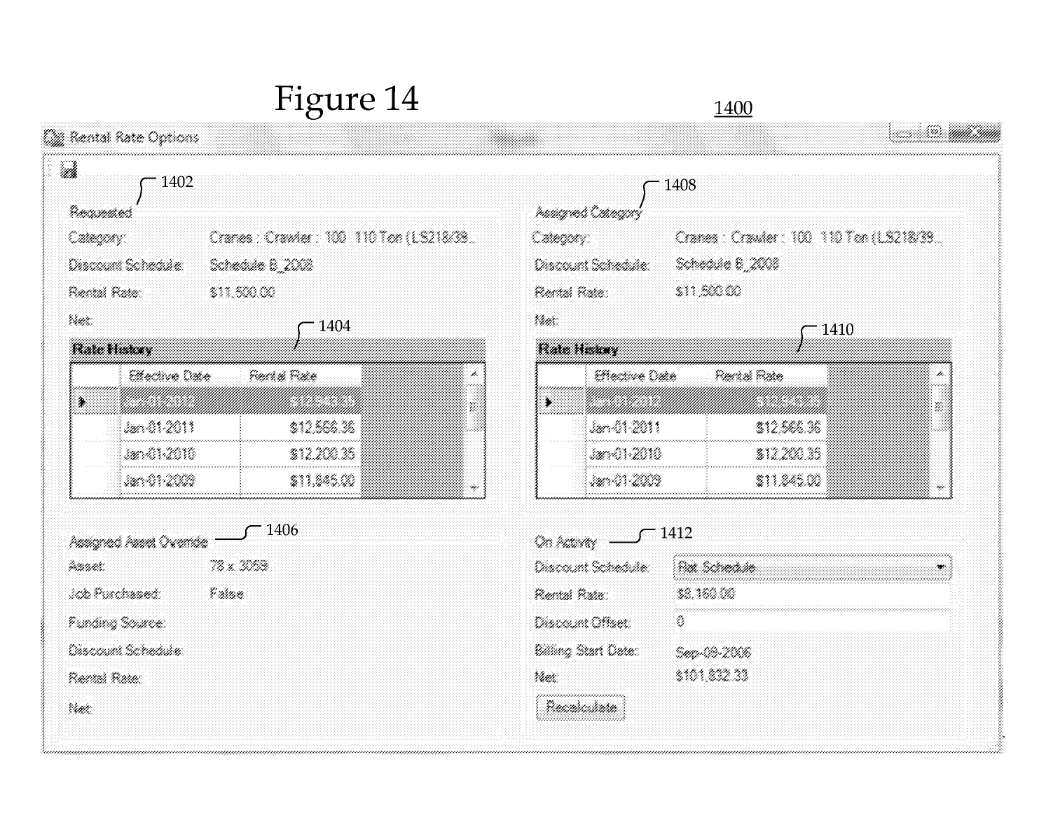

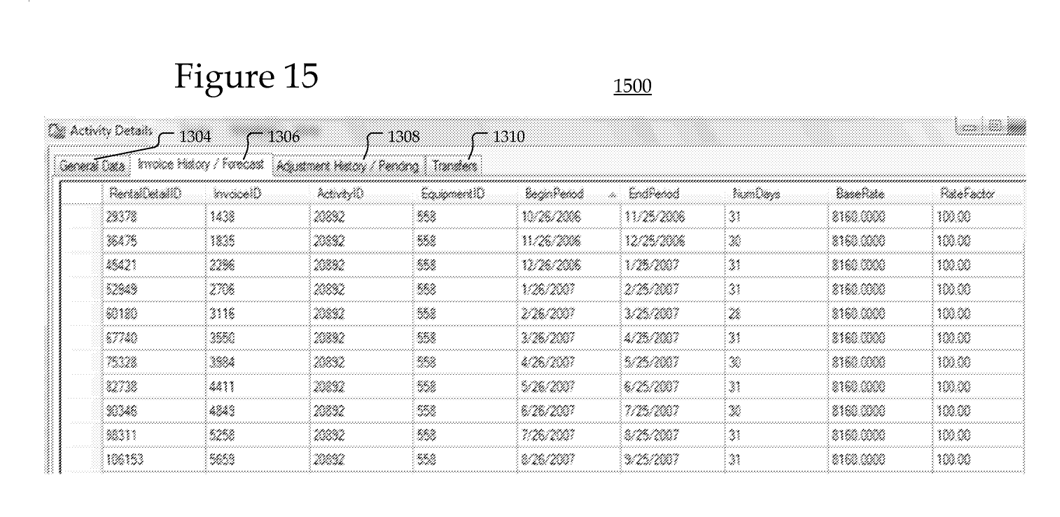

The biller 206 may include the functions of renting or reserving equipment from the scheduler 202. In particular, the biller 206 may establish the rental rates for reserving a piece of equipment at a job site (FIGS. 14-15). A particular project/job site may then be billed only for the equipment that is being used at that job site. The biller 206 may track the cost of equipment compared with the rent or charge from a particular job to maximize the profits at a job or with a particular piece of equipment.

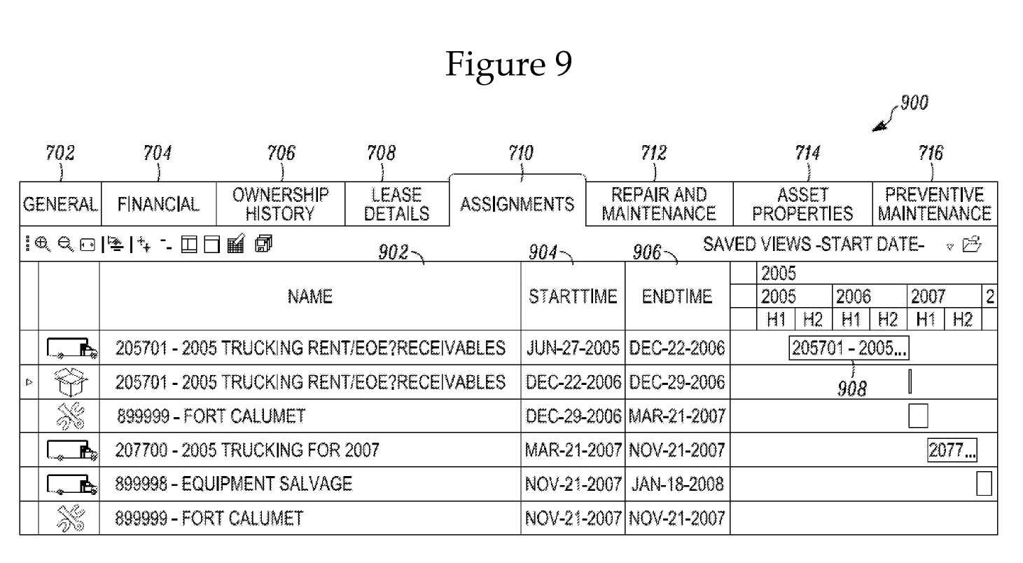

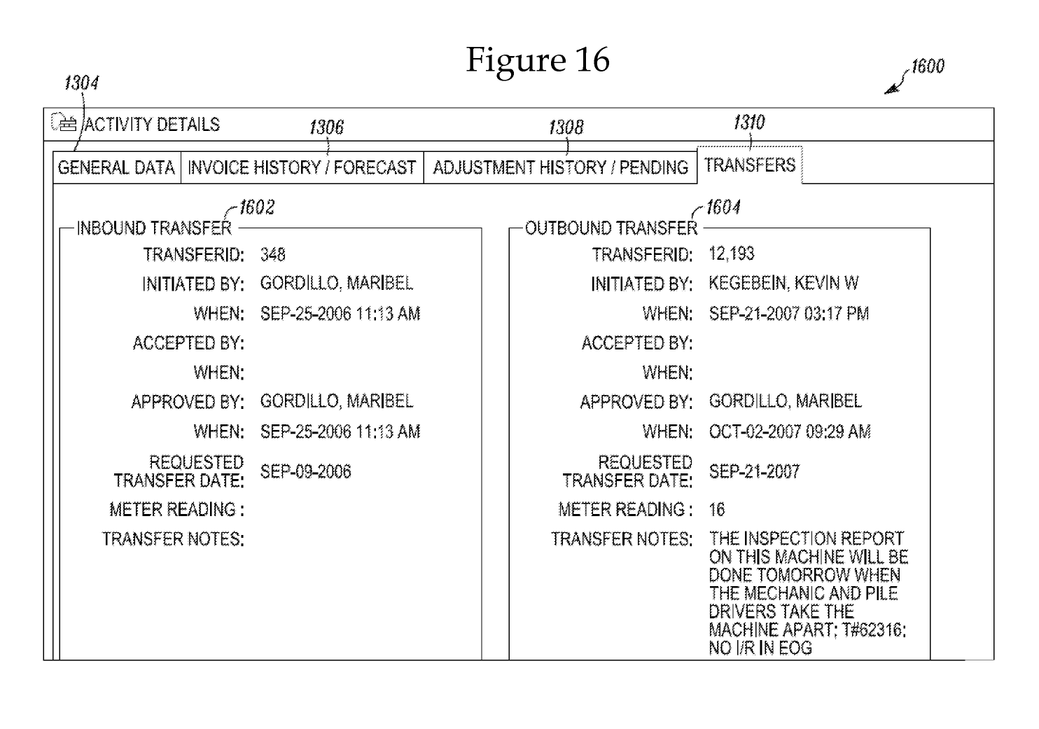

The tracker 208 may include similar functions as the monitor 204 and/or the schedule 202. In one embodiment, the tracker 208 may record locations and positions of equipment (FIG. 9). The equipment user, such as the job site operator 120, may record the usage of a piece of equipment, such as the miles on a car, or hours using a crane. The usage information may be tracked and used by the monitor 204 for updating/monitoring the maintenance of the equipment and for identifying future repairs. In addition, the tracker 208 may include activity data, such as job site information (FIG. 13). When equipment is transferred between job sites, the tracker 208 tracks the transfer of the equipment (FIG. 16). As described above, the functions of the tracker 208 may be performed by the monitor 204, or the functions of the monitor 204 may be performed by the tracker 208.

FIGS. 3-24 are exemplary screen shots illustrating various functions of the equipment management system 102. In particular, FIGS. 3-23 include exemplary interfaces for accessing and interacting with the equipment management system 102 and may involve any of the scheduler 202, monitor 204, biller 206, tracker 208, or any additional functions.

FIG. 3 is an exemplary equipment list 300, which may also be referred to as an inventory list. The monitor 204 may include an inventory manager for viewing available inventory. The equipment list 300 is shown as tabular data 302. The schedule view 304 of equipment is shown in FIG. 4. The equipment list 300 displays equipment that is available according to a categories list 307 and sub-categories. Alternatively, a search 306 may be utilized to find a specific piece of equipment or a specific category of equipment. The equipment type categories shown in the list 300 include cranes 308 as an exemplary equipment type. Other exemplary equipment types are illustrated in the categories list 307. A sub-category of the cranes category 308 includes the crawler 310 sub-category. The crawler may be a type of crane. Further, there is a list of equipment within the crawler 310 sub-category. In particular, the “300 Ton” 312 is an exemplary equipment model that is a sub-category of the crawler 310 sub-category.

When a category or any level of sub-category is selected, the matching equipment 314 is displayed. In FIG. 3, the sub-category crawler 310 is selected, so the matching equipment 314 displays all crawlers. If a specific type of crawler was selected in the category listing 307, such as the “300 ton” 312, then the matching equipment 314 would display the equipment matching the equipment model “300 ton” 312. The matching equipment 314 listing includes various information about the matching equipment, such as the category 316 of the matching equipment. In addition, the equipment identifier, make, model, serial number, and a description may be displayed with the matching equipment. In one embodiment, the exemplary equipment list 300 may be a screen 300 that is used by the job site operator 120 for identifying equipment and obtaining additional information about the equipment.

FIG. 4 is an exemplary schedule view 400. The schedule view 400 may be utilized for viewing the schedule or reservations for equipment. The job site operator 120 may utilize the schedule view 400 for finding equipment to request, or the administrator 128 may utilize the schedule to see where the equipment is or will be for tracking or billing purposes. The schedule view 400 includes a graphical display of a time frame 402. In one embodiment, bars are shown extending over time periods within the time frame 402 to represent particular activities during that time period. The time frame 402 that is shown in the schedule view 400 may be adjustable. For example, for equipment that is transferred frequently, the time frame 402 may be displayed over several months to several years. Conversely, for equipment that is infrequently transferred, the time frame 402 may cover 10 or more years.

The list of equipment 404 is displayed with a graphical view of the schedule for each piece of equipment. For an exemplary piece of equipment, the “3022” 404, the schedule is shown from the 3^{rd} quarter of 2006 into 2009. As shown, a first job 406 lasts from the 3^{rd} quarter of 2006 until the 3^{rd} quarter of 2007, at which time a transfer 408 occurs. The equipment is transferred to a second job 410 that begins in the 4^{th} quarter of 2007 and lasts into 2009. In one embodiment, the bar color may represent the status of a given activity. For example, historical assignments which were billable may be colored yellow, assignments which reflect idle and unutilized equipment may be colored red, current assignments which are being utilized by a jobsite may be colored orange, and future activities may be colored blue.

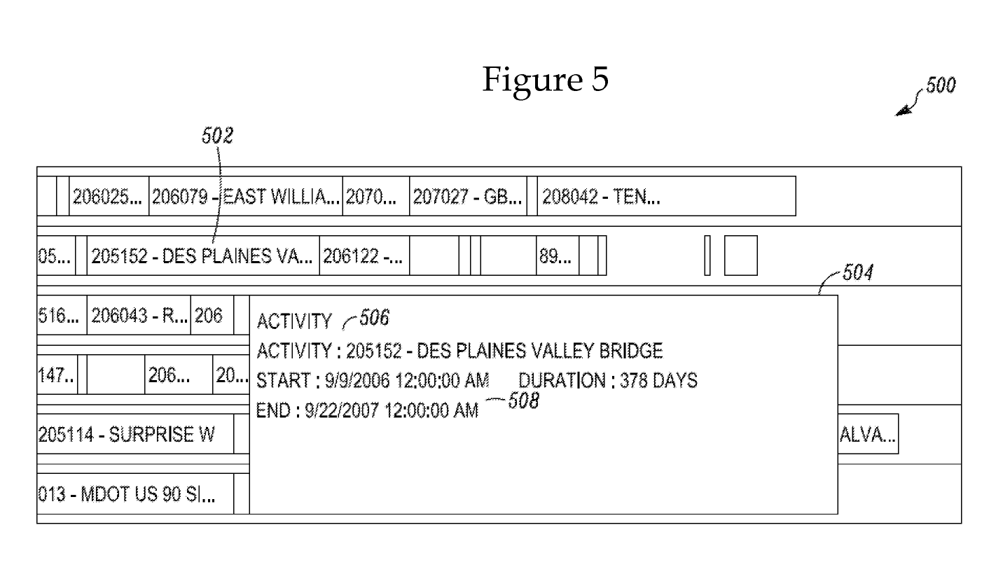

FIG. 5 is an exemplary selection view 500 from another schedule view 400. The selection view 500 may be displayed over a portion of the schedule view 400. In particular, when one of the activities from the schedule view 400 is either highlighted or selected, such as the highlighted activity 502, the activity box 504 is shown. The activity box 504 may be shown when the cursor is hovered over any particular activity, such as the highlighted activity 502. Alternatively, a left-click, right-click, or double-click may display the activity box 504. The activity box 504 may include details for a particular activity (also referred to a job or project), such as the activity identification 506. The identification may include the name of the activity. The timing 508 of the activity 506 may also be displayed in the activity box 504. The timing 508 may include a start date/time, an end date/time, and a duration during which the equipment is reserved for the activity.

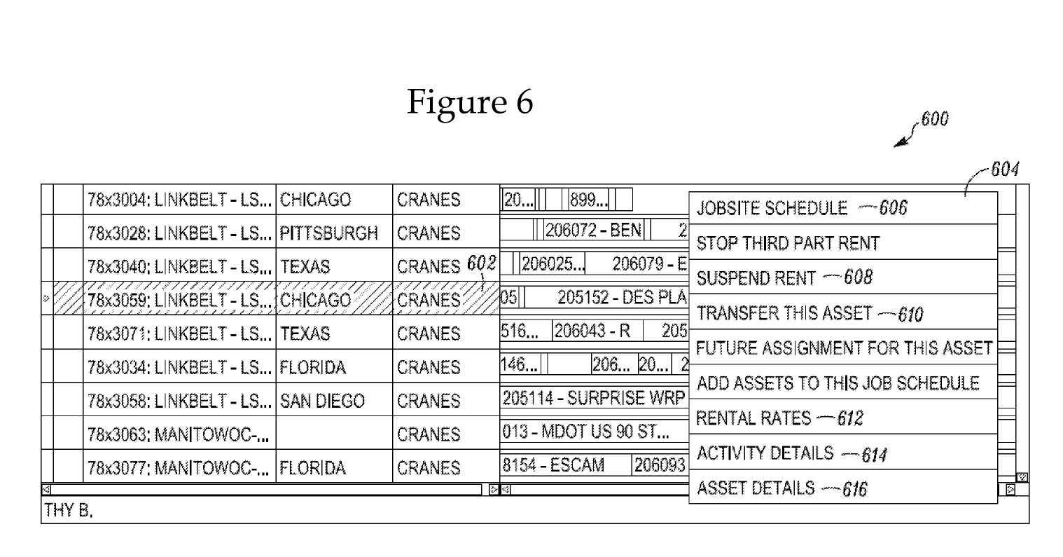

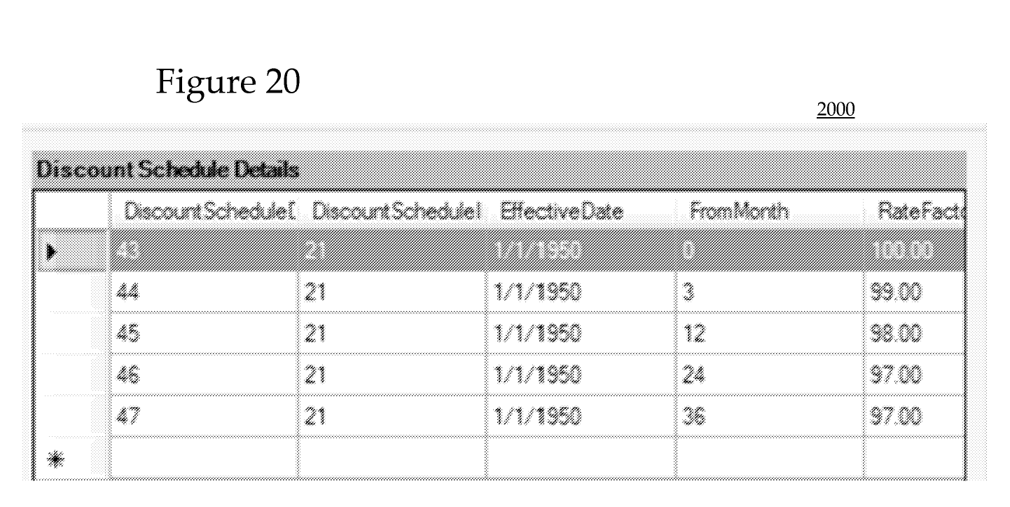

FIG. 6 is an exemplary selection view 600 from another schedule view. The selection view 600 may be a portion of the schedule view 400. When a piece of equipment is selected, such as the highlighted equipment 602, the user may trigger a menu box 604 for options regarding the highlighted equipment 602, or a highlighted job. The selection may include a right-click or a left-click on a piece of equipment, or a particular job associated with a piece of equipment. The jobsite schedule button 606 may display the equipment for a particular job in a schedule view. The suspend rent button 608 may allow for the renting of a piece of equipment to be suspended. In one embodiment, only the administrator 128 and/or the equipment owner 124 may suspend the rent of a piece of equipment. The suspension may be for maintenance or repairs. The rental rates button 612 displays the rates for a piece of equipment as illustrated in FIGS. 14 and 20. The rental rates may be a function performed by the biller. The activity details button 614 may display additional information and data regarding a job. The activity details for a particular job are illustrated in FIGS. 13-16. The asset details button 616 may display additional information and data regarding a piece of equipment. The asset details for a particular piece of equipment are illustrated in FIGS. 7-12.

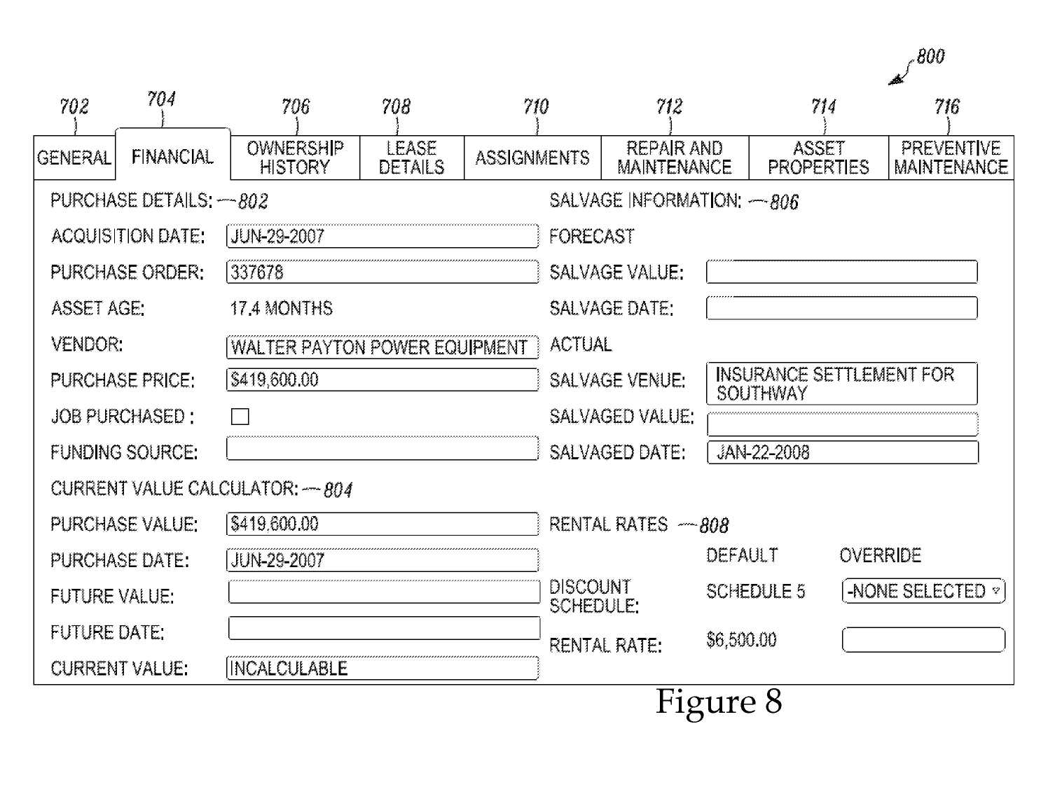

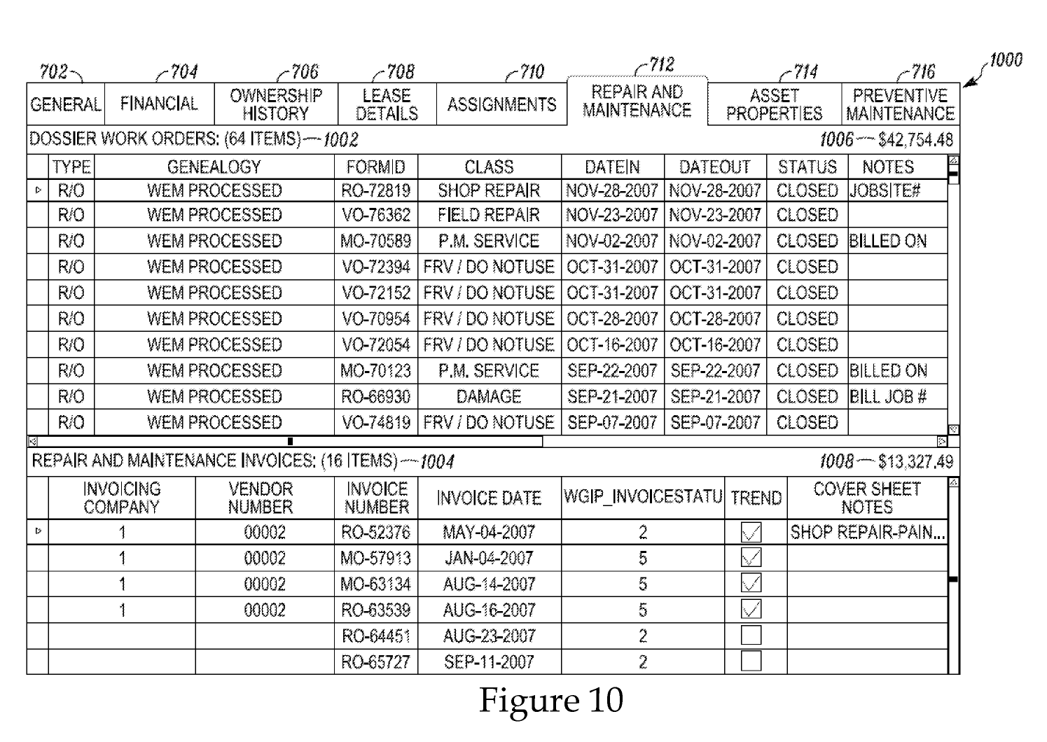

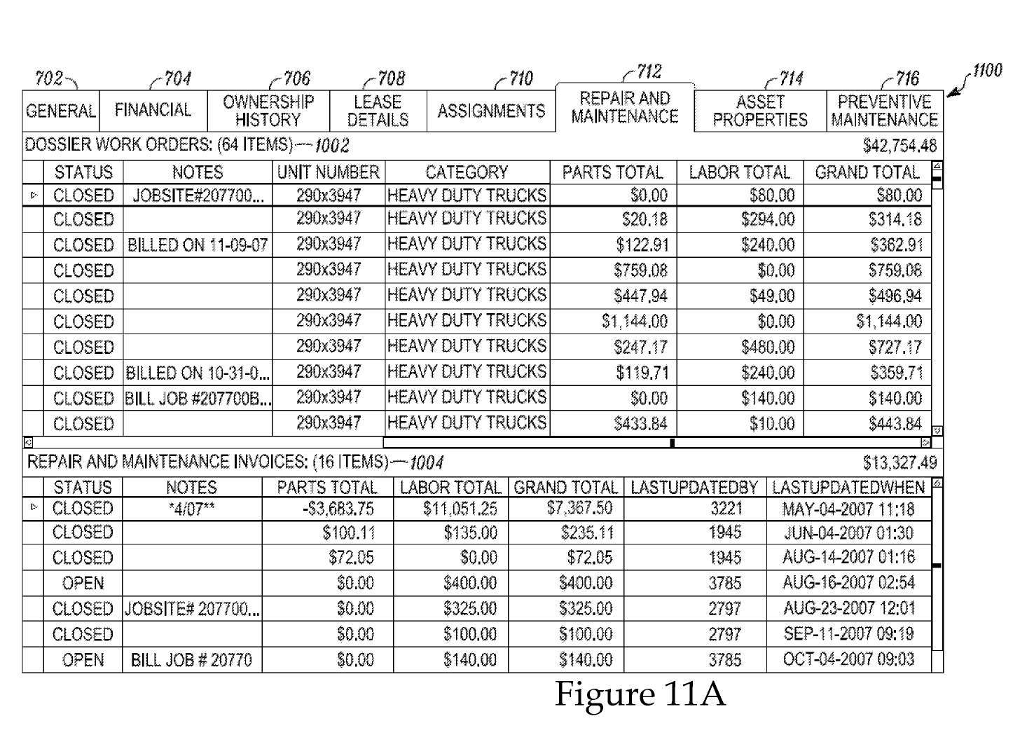

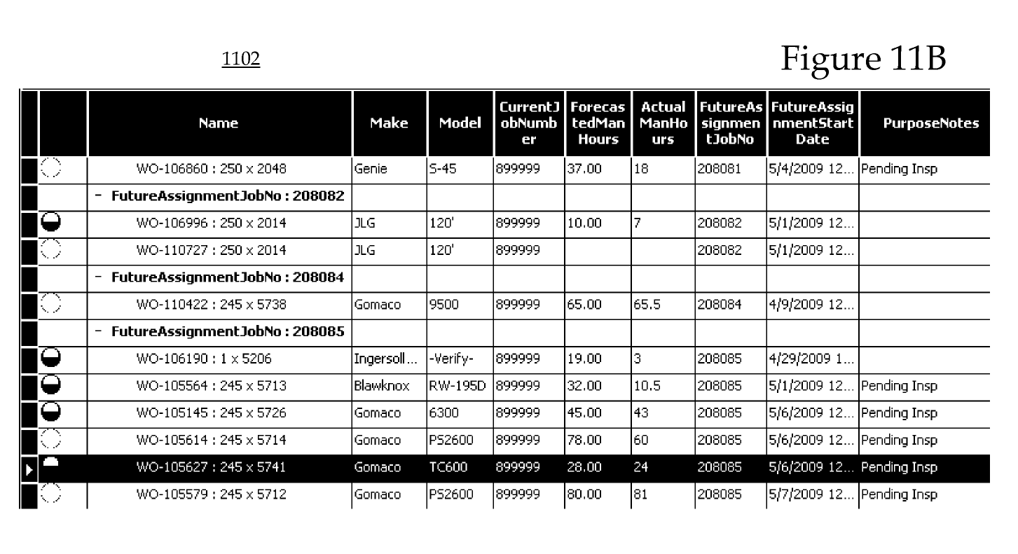

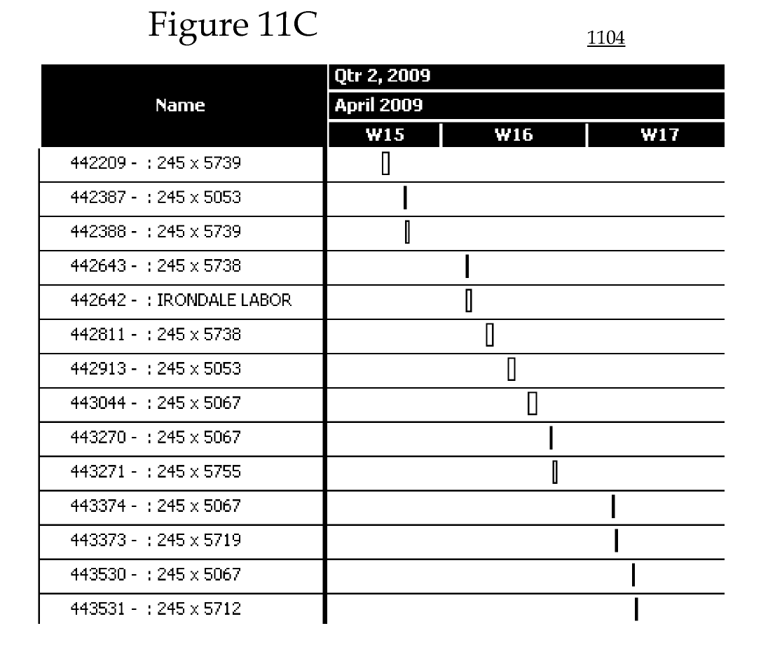

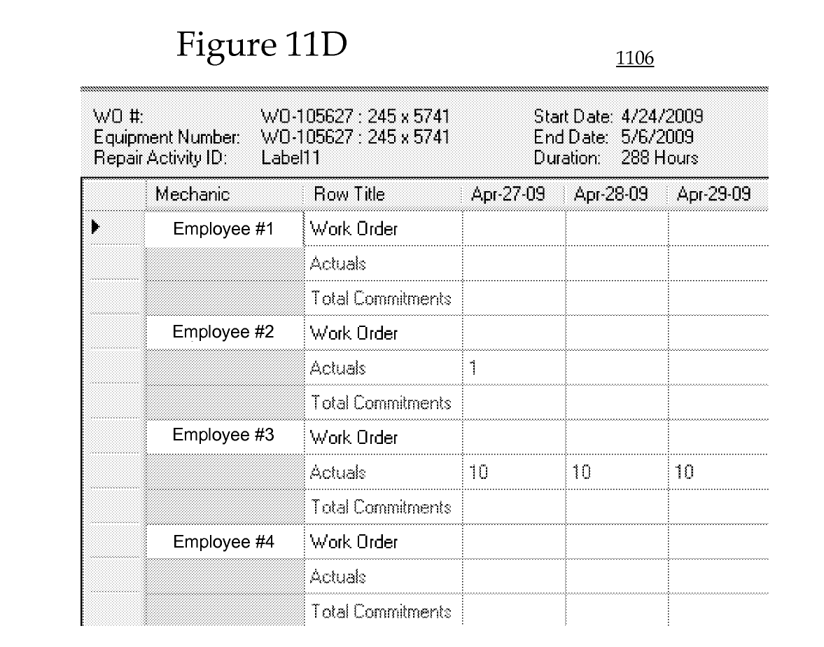

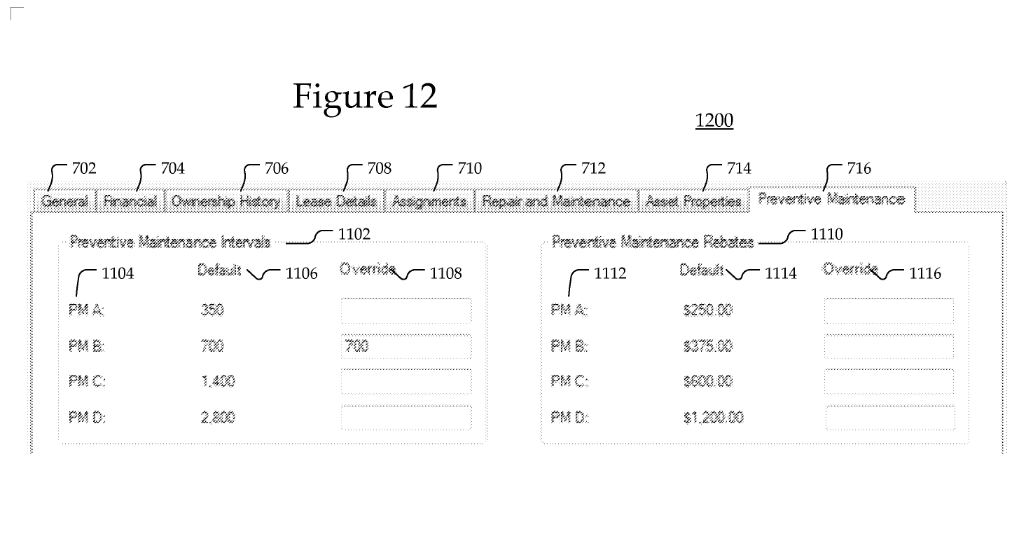

FIG. 7 is an exemplary equipment details screen 700. In the schedule view 600 from FIG. 6, a selection of the asset details button 616 may display the equipment details screen 700. The equipment details screen 700 illustrates general details 702 of the equipment. Other options for equipment details are illustrated in the tabs of the equipment details screen 700. Additional details that may be displayed include financial details 704, ownership history details 706, lease details 708, assignment details 710, repair and maintenance details 712, asset properties details 714, and/or preventative maintenance details 716. The financial details 704 are illustrated in FIG. 8. The ownership history details 706 may describe previous and current owners, such as the equipment owner 124. The lease details 708 may include a leasing history for the equipment. The assignments details 710 are illustrated in FIG. 9. The repair and maintenance details 712 are illustrated in FIGS. 10-11. The asset properties details 714 may include specific properties of equipment, such as individual dimensions, weights, or permitting requirements for a given asset. The preventative maintenance details 716 are illustrated in FIG. 12.

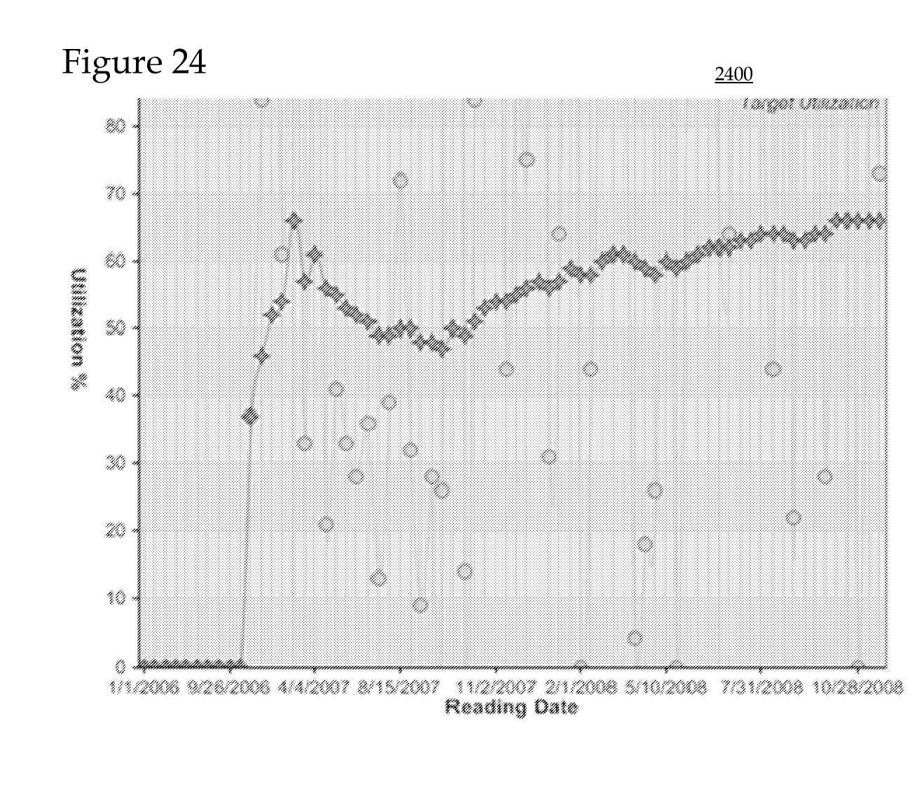

The general details 702 may include an asset number 720 and asset class. The asset number 720 may be an equipment model and/or an equipment name. The equipment may include a status 722 that identifies a current condition of the equipment, such as active, inactive, disabled, retired, in repair, or in transit. The condition 724 of the equipment may also be displayed. The condition 724 may identify the wear and tear on a piece of equipment. A rating system may be used to categorize the condition of equipment, such as a percentage the represents a range of conditions from new to unusable. The target utilization 726 represents the goal of the administrator 128 for making use of the equipment. In other words, the target utilization is a percentage of time that for which the equipment should be used. In other words, since the target utilization is 95%, the equipment should not be unassigned or unused for more than 5% of the time. The target utilization 726 is further discussed below with respect to FIG. 24. The useful life 728 of the equipment may be measured in hours of use, or another metric, such as miles traveled for a vehicle. The useful life 728 may be used for monitoring the lifetime of equipment so that new equipment may be purchased when old equipment approaches or passes its useful lifetime. The override 730 may be used by the administrator 128 to adjust or reset the target utilization 726 and/or the useful life 728. Finally, the general details 702 may include manufacturer information 732. The manufacturer may be the equipment owner 124 when the administrator 128 is renting the equipment. The manufacturer information 732 may include make, model, model year, serial number, warranty date, and/or warranty meter.

FIG. 8 is an exemplary equipment details screen 800 for financial details 704. The financial details screen 800 displays financial details for a piece of equipment. The equipment purchase details 802 may include the date, purchase order, age, vendor, purchase price, funding source, and whether it was purchased for a particular job. A current value calculator 804 may be used for determining the current value of equipment using the purchase value and purchase date along with a future value. Salvage information 806 may include information for equipment that may have been salvaged. The salvage information 806 may include the salvage value, date, and venue. Rental rates 808 may also be listed under the financial 704 view. The rental rate 808 may include the current or future rate, as well as a rental rate schedule that is being used for the current piece of equipment. The rental rate 808 is discussed below with respect to FIGS. 14-15.

FIG. 9 is an exemplary equipment details screen 900 for assignment details 710. The assignment list may include the jobs that a particular piece of equipment is assigned to. The term assignment may refer to a renting or scheduling of a equipment for a particular job. The assignment of equipment to a job may include a cost (such as rent) that is paid for the use of the equipment. The name list 902 includes jobs that the equipment is assigned, along with the start time 904 and the end time 906 for each of those jobs. The timing for each job may also be graphically displayed as bars 908 that extend over the time period that it is assigned to a particular job site.

FIG. 10 is an exemplary equipment details screen 1000 for repair and maintenance details 712. The repair and maintenance details tab 712 may illustrate the work orders 1002 and repair invoices 1004 for a piece of equipment. The work orders 1002 may include a total amount 1006 spent for the equipment, as well as a listing of each work order. The work order listing 1002 may include the type, genealogy, class, date in, date out, status, and notes for each work order. The repair and maintenance listing 1004 may include a total amount of invoices 1008, as well as the invoicing company, vendor number, invoice number, invoice date, and other data for each invoice for the equipment.

FIG. 11A is another exemplary equipment details screen 1100 for repair and maintenance details 712. FIG. 11A is an additional view of the repair and maintenance details tab 712 that includes additional categories of information that are not shown in FIG. 10. In particular, for the work orders 1002, a unit number, category, parts total, labor total, and grand total are illustrated. For the repair and maintenance invoices 1004, the parts total, labor total, grand total and update time are illustrated. Additional data or information may also be displayed regarding the repair and maintenance of the equipment.

The repair and maintenance details tab 712 may include a repair forecasting tool. Alternatively, the repair forecasting tool may be displayed in a different screen, such as in a separate tab. The repair forecasting tool may calculate and display an estimate for the timing of repair of particular equipment. The repair forecasting tool may be combined with the scheduling functions for scheduling the timing and duration of repairs. For example, if a repair is scheduled to be completed in one month, then that piece of equipment may be listed as available one month from now.

FIGS. 11B-11D are exemplary partial screen shots illustrating various features of the repair forecasting tool. FIG. 11B is an exemplary screen 1102 for resource scheduling that displays a work order view. In particular, screen 1102 illustrates a list of equipment (Name) that includes the make, model and job number (CurrentJobNumber). For each piece of equipment, there may be a forecasted man hours value (ForecastedManHours) and an actual man hours value (ActualManHours). The forecasted man hours represent the estimated repair time for that piece of equipment the actual repair time is the time it actually took to repair the piece of equipment. Actual costs, as each repair order is performed, may accumulate. The total amount of actual costs may be compared with the forecasted costs in order to measure the accuracy of repair order estimates. Based on the review of actual costs, future forecasted costs may be adjusted. For example, if actual costs commonly exceed the costs that were forecasted, then the future forecasts may be increased. In alternate embodiments, each job may be displayed graphically based on the time period in which it has been subject to repair and the estimated time needed for repair.

FIG. 11C is an exemplary screen 1106 for resource scheduling that displays a personnel schedule view by employee. In one embodiment screen 1104 may also include a directory or search function for searching by personnel or repair workers. For a given worker, screen 1104 lists the jobs or pieces of equipment (Name) that the worker has worked on over a certain period of time. That period of time may include past, present, and future jobs. As shown, the time is broken down by weeks (week 15, 16, 17) in April 2009. The screen 1104 illustrates a bar that represents the time and length that the worker worked on each of the jobs or equipment. The wider the bar, the longer the period of time. In alternate embodiments, the chart may include finer time frames, such as by the day, rather than weekly or quarterly.

FIG. 11D is an exemplary screen 1104 for resource scheduling that displays details by work order. For an individual piece of equipment (Equipment Number), screen 1104 displays the mechanics that worked on that equipment. It may include the actual hours worked, forecasted hours worked, or other hours spent on the equipment. Screen 1104 illustrates four employee mechanics, and as shown, employee #2 worked for one hour on April 27, and employee #3 worked for ten hours on April 27-29 on the equipment.

The cost of repairs and the potential lost costs based on the time the equipment is out for repair may be included in the repair forecasting tool. The repair forecasting tool may allow for a priority function or “need date” in which an urgent repair that is needed by a certain date is given a higher priority so that it is moved ahead of repair orders with lower priorities. Accordingly, the order of repairs may be adjusted based on priority and important or urgently needed equipment may be repaired more quickly. In one embodiment, the repair forecasting tool may allow a user to access the schedule for a piece of equipment to be repaired in order to view the status of that repair, as well as the projected or forecasted repair date.

The repair forecast may be calculated based on the demand for repair (e.g. number of repair orders) compared with the supply for satisfying the repair (e.g. mechanics for performing the repairs). The determination of repair forecasting may be used for updating the availability of equipment. Factors that may affect the demand for repair include the number of repair orders, and the type of repair orders. For example, the repair of a tire may require less time than replacing an engine for a large piece of equipment. The factors that may affect the supply for repair may include the mechanics available, the types of mechanics available, and the physical repair space for storing equipment to be repaired. As discussed above, FIG. 11C is one embodiment for tracking jobs/equipment that a worker has worked on, or is scheduled to work on. In one example, mechanics may be coded based on the type of equipment that they are able to repair. For example, only certain mechanics may be able to work on cranes, which means that the repair time for a crane may be determined based on the availability of mechanics who work on cranes.

The repair forecast tool may calculate an optimal quantity of resources (such as mechanics) required at any given point in time based on total forecasted demand for repairs at any similar given point in time. This process will be predicated upon the input of certain assumptions, including, but not limited to, amount of planned hours per mechanic per workday, amount of planned workdays per work week, certain allowances for overtime, certain allowances for un-planned, emergency, and re-prioritized repair orders, resources are coded based upon the type of equipment that they are able to repair, etc.

In addition, the repair forecast tool may calculate future cost expenditures by extracting the sum product of current and future repair orders based on a total forecasted demand for repairs. Distances into the future of such forecasting may range from one day to one year or as far as currently identified demand and certain allowances for unidentified demand may dictate. For example, if repair orders extend two years out, it may be possible to forecast over two years. Conversely, if repair orders extend a couple of weeks, that may be the time frame for forecasting. Forecasted costs may be utilized to develop earnings forecasts and other financial data, as necessary.

FIG. 12 is an exemplary equipment details screen 1200 for preventative maintenance details 716. The preventative maintenance tab 716 illustrates a maintenance schedule for avoiding repairs and maintenance. In particular, preventative maintenance intervals 1102 may be established for particular time intervals. As illustrated, a default interval 1106 may include a number of hours for each of the maintenance intervals. As shown, the first preventative maintenance is at 350 hours and the second is at 700 hours. The default time value may be overridden 1108 by the manager or equipment owner. The time interval may in time of use, or may be based on another performance metric, such as a miles. The preventative maintenance may result in preventative maintenance rebates 1110 for the equipment. In other words, if the preventative maintenance is satisfied within the time interval a default rebate amount 1114 is provided for each of the scheduled maintenance intervals 1112. The rebate may be an incentive for a job site operator to maintain the equipment. The amounts of the rebates may be overridden 1116 by a manager for increasing or decreasing the rebate amounts.

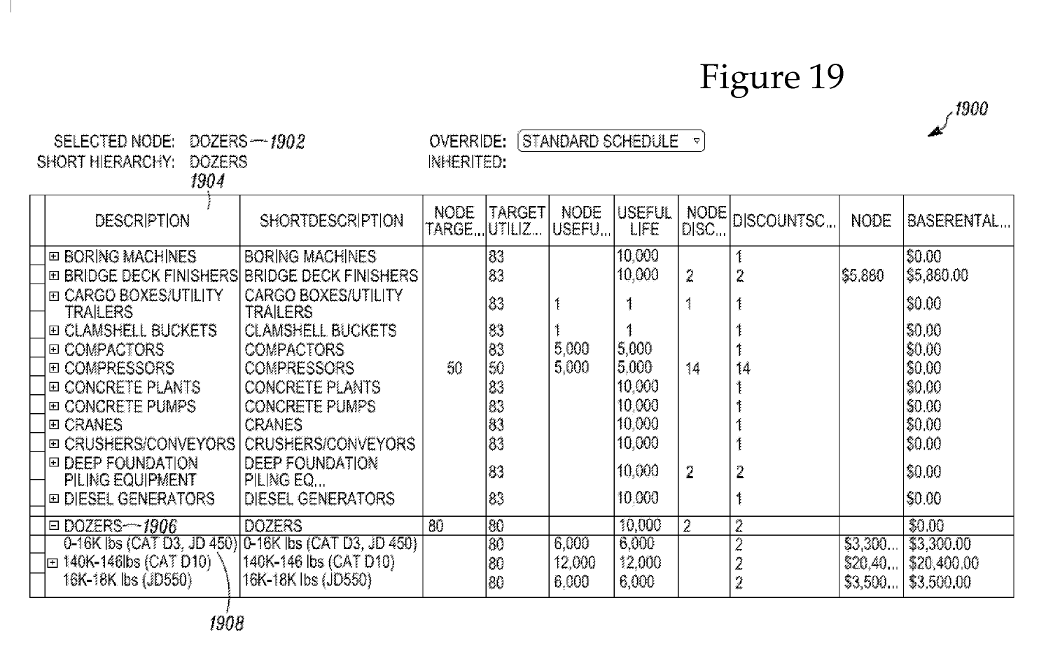

FIG. 13 is an exemplary activity details screen 1300. The activity details screen 1300 displays details for a particular activity. As discussed above, an activity may include a project or a job, such as a construction project. For example, the equipment management system 102 may be operated by a construction company that oversees multiple construction projects or activities. Accordingly, the activity details screen 1300 displays details for a particular activity. The activity details may include general data 1302, such as an activity ID, job number, job name, status, as well as a listing of people in charge or involved with the activity. For example, the construction project manager, such as the job site operator 120 may be listed for the activity. Financial data 1314 for the activity may include the scheduled and billing rates for equipment at a particular job site. The rental rates 1316 may be displayed as in FIGS. 14 and 19 discussed below.

The activity details may be displayed with regard to a particular piece of equipment. The request 1318 may include a requester, a type of equipment, a start date and an end date for a request. As discussed above, a job site operator 120 may request equipment through the equipment management system 102. As shown in the activity details screen 1300, the request may be processed, such that an assignment 320 is made for the request. The request may be processed manually or automatically. In one embodiment, a reviewer of requests may assign equipment based on the requests, or the system may automatically select the equipment to be assigned.

FIG. 14 is an exemplary rate details screen 1400. When the rates button 1316 is selected the rate details screen 1400 may be displayed. In alternate embodiments, the screens from FIGS. 19-20 may also display rental rate information as discussed below. The rate details may include the rental rates for a piece of equipment, or for a category of equipment. The rate details screen 1400 may be utilized by a requester of equipment for specifying a rate that he/she would like to pay for the requested equipment. The requested information 402 may be displayed, including a rate history 1404. As discussed in FIGS. 19-20, the equipment rental rates may be tiered according to different rental schedules. An assigned asset override 1406 may provide the ability to override any default rental rate during unique circumstances that may be intended to follow a specific asset without changing. The assignment information 1408 may include the category, discount schedule, rental rate, and rate history 1410. The “on activity” information 1412 may display the actual rental rate that is assigned to a given activity. This may be the base rental rate that is applied during the invoicing to a given jobsite.

FIG. 15 is an exemplary activity details screen 1500 for invoice history and forecast details 1306. The screen 1500 may display a list of invoices including both past and future invoices for equipment at a particular job site. For example, the future invoices may include equipment that has been assigned at a future date and may not include equipment that is scheduled to be transferred from the job site. The screen 1500 may display a rental ID, an invoice ID, an activity ID, an equipment ID, a begin date for the invoice, an end date for the invoice, the number of days covered by the invoice, the base rate value and the rate factor. As shown, the invoices are distributed monthly, but they may be for a different time period. The rate value may be a rental amount that for the equipment for that invoice and the rate factor is a percentage of the rate that is owed. The tiered rental rate structure or other discounts may result in the rate factor being less than 100%.

FIG. 16 is an exemplary activity details screen 1600 for transfer details 1310. For each piece of equipment, when the assignment at a particular job site expires, the equipment may be transferred to another job site or to a storage area. Information regarding the transfer from or to a job site may be illustrated by the transfer screen 1600. As illustrated, inbound transfer information 1602 may include a transfer ID, initiation, acceptance, approval, transfer date, and meter reading. The initiation, acceptance, and approval may be when the requests are processed manually. Outbound transfer information 1604 may include the same information as the inbound transfer.

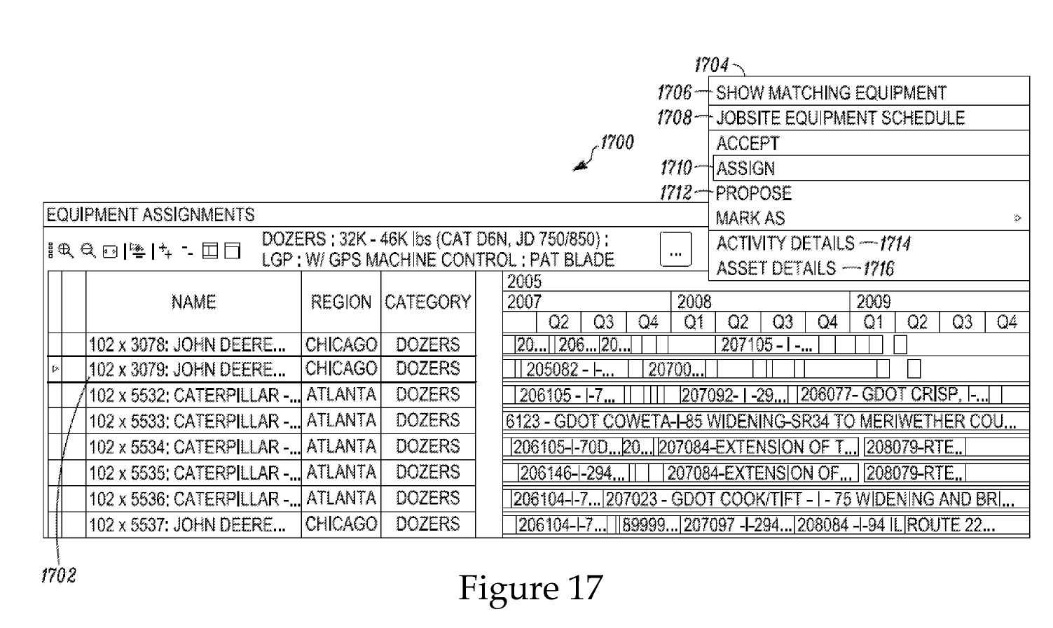

FIG. 17 is an exemplary inventory management screen 1700 for open requests. The inventory management screen 1700 may be the same as or similar to FIGS. 4-6, but may include additional or different functions. In particular, the inventory management screen 1700 may be used for making a request for a piece of equipment, whereas the previous inventory screens may display and provide information about equipment, activities, and the schedules for both. The inventory management screen 1700 may include a listing of equipment assignments with a graphical view of the schedule as discussed above. A manual operator of the equipment management system 102 may view the graphical schedule for selecting equipment for a request. In particular, the menu 1704 may be displayed for the selected equipment 1702 when a user selects (left click, right click, double click, or other selection mechanism) the selected equipment 1702 from the equipment assignments list.

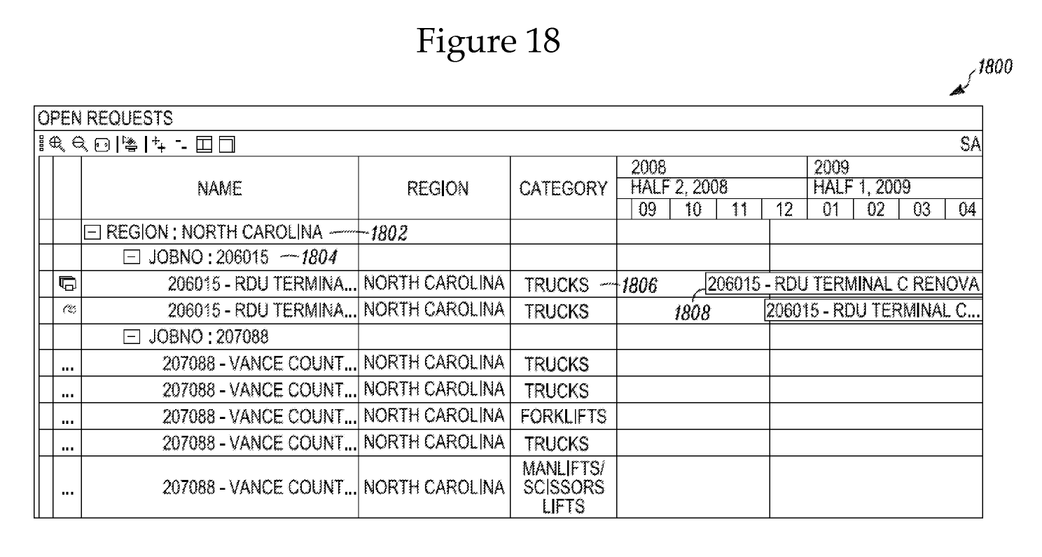

The menu 1704 displays options for the selected equipment 1702. In particular, when the selected equipment 1702 is a category of equipment, the show matching equipment selection 1706 may list or display the equipment that matches the selected category. The jobsite equipment schedule 1708 may display equipment for a particular job as illustrated in FIG. 18. The assign selection 1710 and the propose selection 1712 may allow for equipment to be assigned or propose an assignment, respectively. The menu 1704 may also include a selection for viewing activity details 1714 and/or asset details 1716 for a selected activity or equipment.

FIG. 18 is an exemplary jobsite listing screen 1800 of open requests. The listing screen 1800 may display a list of requests for different jobs. In particular the jobs may be categorized by region 1802. As illustrated, the selected region 1802 is North Carolina. The particular job 1804 is displayed with a request 1806. The request 1806 is for a truck and the schedule 1808 illustrates the availability of the truck over a certain time period. As with the inventory screens, the schedule or assignments of equipment may be graphically displayed as bars over a period of time. The listing screen 1800 may indicate requests from the job site operator 120 that have not yet been finalized (approved/submitted). In an alternative embodiment, the listing screen 1800 may also display equipment assignments as illustrated in FIG. 17.

FIG. 19 is an exemplary rental rate screen 1900. The rental rate screen 1900 may illustrate the rental rates for equipment in a hierarchy of categories. As illustrated, the selected node 1902 is for dozers, as illustrated by the selection of the dozers category 1906. The listing 1904 includes a number of categories that further include additional sub-categories of equipment or a listing of the equipment. Within the dozers category 1906, a specific dozer type 1908 is illustrated. For the listing 1904 of categories/equipment, the rental rate screen 1900 may include a description, a target utilization, a useful life, a discount or discount schedule, and a base rental rate. In one embodiment, the rental rate screen 1900 may be utilized by the administrator 128 for establishing utilization levels for equipment. The utilization levels may represent a goal for an amount of usage for each piece of equipment to ensure that equipment is not being unused. It may be expensive and inefficient for a construction company to own/control lots of equipment that is not being used frequently. The useful life may be representative of an amount that the equipment should last through, such as hours of usage. The discount schedule may include a reduction of the base rate as a discount.

FIG. 20 is an exemplary rate schedule screen 2000. The rate schedule may include a tiered rental rate in which the rate decreases over time. The rate may be a percentage of a base rental rate. For example, the rate may be 100% for the first three months, the rate may be 99% from months 3-12, the rate may be 98% from months 12-24, and the rate may be 97% from months 24-36. The tiered rental rate may include a built in percentage discount based on the length of rental that provides discounts for longer rental periods. The rates shown in FIG. 12 are merely exemplary, and the time periods and/or discounts may be modified.

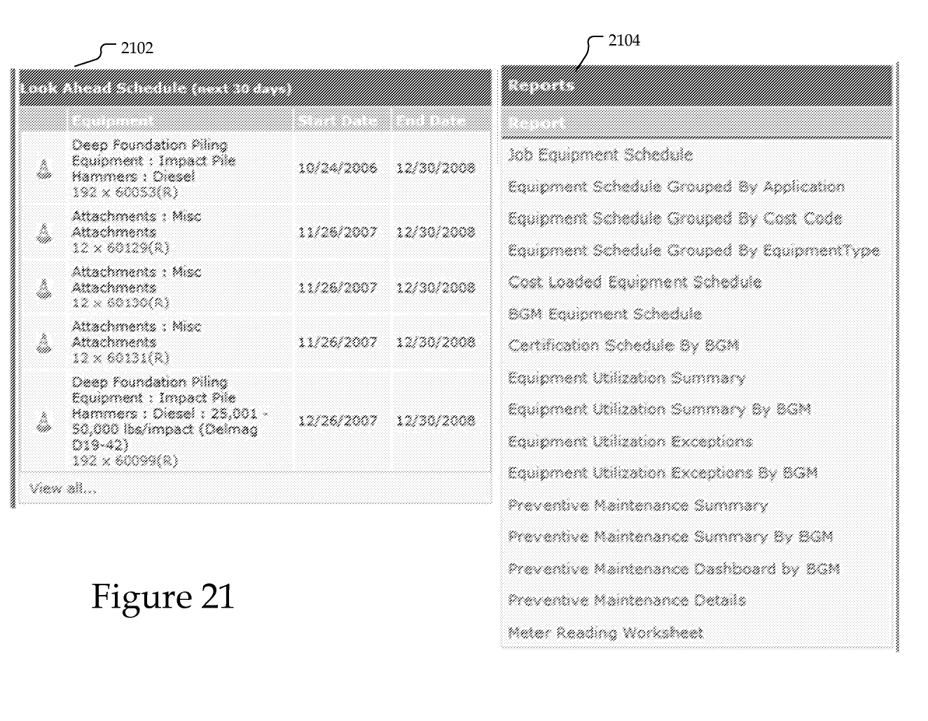

FIG. 21 is a screen shot of functions for a job site operator. In particular, a look ahead schedule 2102 may be accessible by the job site operator 124 for reviewing a list of equipment that may be transferred. The look ahead schedule 2102 illustrates the equipment whose end date is within 30 days, so that the jobsite operator 124 can prepare for the transfer of equipment. A report list 2104 may provide access to specific information regarding the operator's job and equipment. In addition, the job site operator 124 may view a report or display regarding upcoming preventative maintenance, equipment invoice history, and/or equipment notifications. Further, the job site operator 124 may view the status for pending requests as well as any finalized and/or denied requests for equipment.

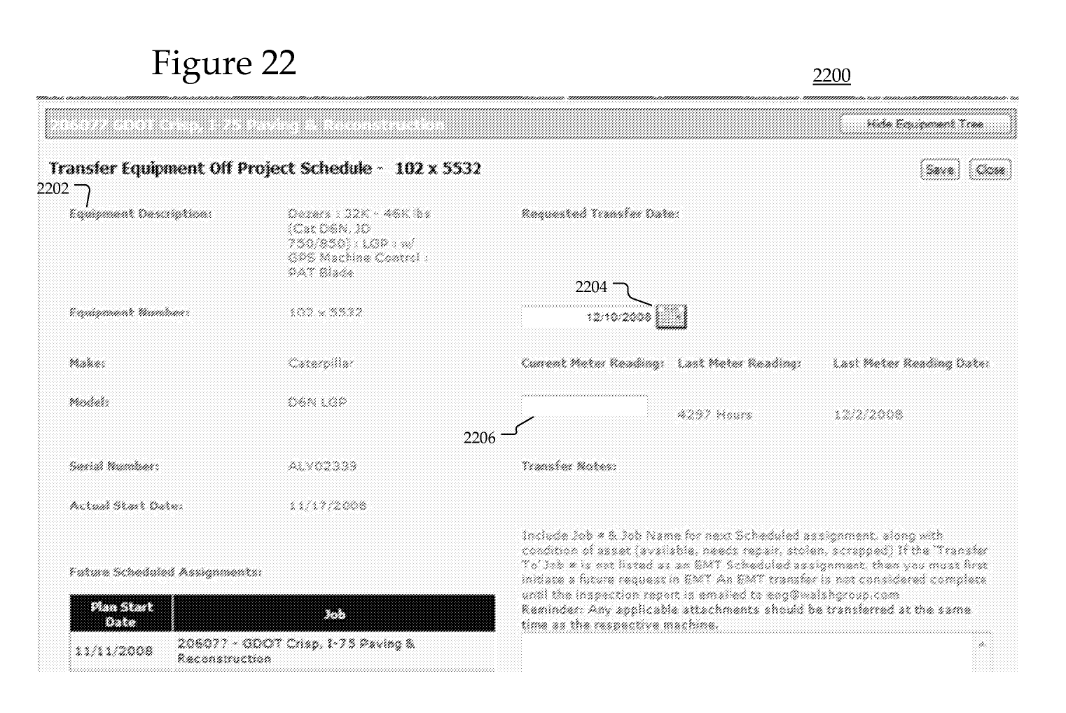

FIG. 22 is a transfer request screen 2200. A requester, such as the job site operator 124, may access the transfer request screen 2200 in order to request a transfer for a piece of equipment. The equipment description 2202 may describe the equipment and include an equipment number, a make, a model, a serial number, an actual start date, a requested start date, and future job s. The requested transfer date 2204 is filled in by the requester, as well as a current meter reading 2206. The meter reflects the usage of the equipment.

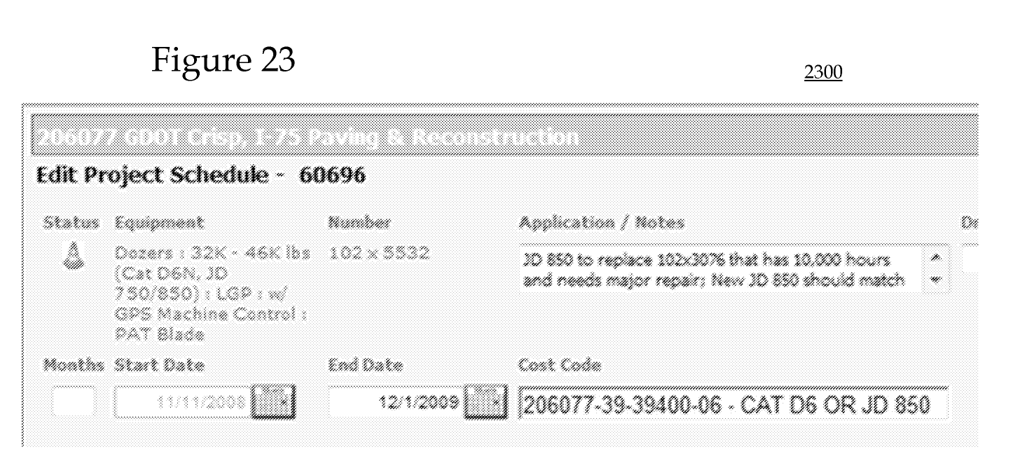

FIG. 23 is an exemplary equipment request screen 2300. A requester, such as the job site operator 124 may request equipment by selecting a piece of equipment from an inventory list, such as in FIGS. 3-4. The selected equipment may then be requested for a certain number of months, with a selected start date and end date.

FIG. 24 is a chart 2400 of target utilization. Utilization is the ratio of the hours an asset is actually used to the hours the asset was available for use. The utilization chart may display historical equipment utilization derived from the hours consumed on a specific piece of equipment. Both the period-specific and accumulated utilization may be displayed in the graph. The target utilization may be the standard used to determine if an asset is being used appropriately and within the normal business model. The actual hours consumed may be compared to a predetermined monthly allowance in order to compute the utilization of a given asset.

The screen shots illustrated in FIGS. 3-24 are exemplary representations of some of the functions of the equipment management system 102. The screen shots may be accessible by the job site operator 120, the equipment owner 124, or the administrator 128. Certain functions may only be accessible by the administrator 128. For example, the administrator 128 may edit or determine the rental rate schedule and any discounts. Further, the administrator 128 may access and submit invoices. In one embodiment, the scheduling of assets is performed by the administrator 128 based on requests received from the job site operator 122. The administrator 128 may review the requests and the inventory lists in order to assign the proper equipment based on the requests. Alternatively, the system may automatically assign equipment based on a number of factors, such as temporal availability, current location, availability of transportation, etc.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

We claim:

1. A computerized method for assigning equipment to a job site, the method comprising:
receiving a request for a piece of equipment from a job site operator;
providing a graphical display of a list of categories of equipment that comprises a plurality of sub-categories that are selectable for matching the request, wherein the categories and the sub-categories comprise a hierarchical display that narrows down available equipment within each level of sub-category;
displaying, as part of the hierarchical display, an identification and description of equipment within a selected one of the categories or sub-categories;
receiving a narrowing selection from the graphical display that corresponds with one of the categories and at least one of the sub-categories for narrowing down available equipment;
matching and displaying equipment from the available equipment based on the narrowing selection;
providing a schedule for the matched and displayed equipment, wherein the schedule displays upcoming usage for each of the matched and displayed equipment;
receiving a selection of equipment from the schedule for assigning equipment based on the request to the job site; and
updating, based on the selection, the schedule for the selected equipment as assigned and associated with the job site.

2. The method of claim 1 wherein the description of equipment in the hierarchical display further comprises a make, a model, and a serial number of displayed equipment, or the description of equipment in the hierarchical display further comprises a past usage and geographical location of displayed equipment.

3. The method of claim 1 wherein the hierarchical display further comprises a pricing that is displayed, further wherein the pricing comprises rental rates.

4. The method of claim 1 wherein each of the requests that are received are displayed on the hierarchical display, the method further comprising:
receiving a matching selection of one of the requests with one of the equipment from the schedule.

5. The method of claim 1 wherein the hierarchical display is not available to the job site operator and is operated by an administrator.

6. An online equipment system for monitoring equipment comprising:
a web server coupled with a network; and
an equipment management system coupled with the web server, wherein the web server provides access to the equipment management system over the network, the equipment management system comprising:
a job site interface for a job site operator to access a list of the equipment assigned to the operator's job site and to access a list of equipment that is available;
an administrator interface for displaying an inventory manager and for displaying a scheduler, wherein the inventory manager displays inventory of equipment and the scheduler displays a schedule for the equipment;
wherein the administrator interface further comprises a repair prediction display and a preventative maintenance display, the preventative maintenance display comprises timing and rebates for maintenance, further wherein the repair prediction display displays a repair time estimate that is based on repair for similar equipment and displays a forecasted cost and an actual cost, each of which are updated as a repair occurs.

7. The online equipment system of claim 6 further comprising:
an inventory manager for displaying inventory of equipment;
a scheduler for assigning equipment to the job site and for transferring equipment from the job site, wherein a request is received at the scheduler from the job site operator for assigning equipment, further wherein the scheduler maintains a schedule for each piece of equipment from the inventory manager and maintains a schedule for each of the job sites; and
a biller for establishing rental rates for the equipment and charging for the assigned equipment.

8. The online equipment system of claim 7 wherein the scheduler maintains a schedule for each piece of equipment from the inventory manager and for each of the job sites, and wherein the interface is configured to allow the operator to request additional equipment from the inventory and update a status of equipment at the job site.

9. The online equipment system of claim 7 wherein the repair prediction display is combined with the scheduler for scheduling timing and duration of repairs.
